(19) United States
(12) Patent Application Publication
(10) Pub. No.: US 2025/0338297 A1
(43) Pub. Date: Oct. 30, 2025

(54) COMMUNICATION APPARATUSES AND COMMUNICATION METHODS FOR SIDELINK CO-CHANNEL COEXISTENCE OF LTE AND NR

(71) Applicant: Panasonic Intellectual Property Corporation of America, Torrance, CA (US)

(72) Inventors: Yang KANG, Singapore (SG); Hidetoshi SUZUKI, Kanagawa (JP); Ayako HORIUCHI, Kanagawa (JP); Hong Cheng Michael SIM, Singapore (SG); Xuan Tuong TRAN, Singapore (SG)

(21) Appl. No.: 18/855,274

(22) PCT Filed: Mar. 13, 2023
(86) PCT No.: PCT/SG2023/050159

§ 371 Date: Oct. 8, 2024

(30) Foreign Application Priority Data
Apr. 28, 2022 (SG) 10202204586V
Jun. 3, 2022 (SG) 10202250034Y

(51) Int. Cl. H04W 72/40; H04W 72/25; H04W 72/56

(52) U.S. Cl. CPC H04W 72/40; H04W 72/25; H04W 72/56

(57) ABSTRACT

The present disclosure provides communication apparatuses and communication methods for SL co-channel coexistence of LTE and NR. The communication apparatuses include a communication apparatus comprising: circuitry, which in operation, selects a category from a plurality of categories including: a first category relating to a plurality of resources only for Long Term Evolution (LTE) sidelink, the LTE sidelink comprising LTE data and/or LTE sidelink control information (SCI), a second category relating to a plurality of resources only for New Radio (NR) sidelink, the NR sidelink comprising NR data and/or NR SCI, and a third category relating to a plurality of shared resources shared by the LTE sidelink and NR sidelink; and a transmitter, which in operation, transmits a sidelink data and/or SCI based on the selected category, wherein the sidelink data is the LTE or NR sidelink data and the sidelink SCI is the LTE or NR SCI.

### TECHNICAL FIELD

The present disclosure relates to communication apparatuses and communication methods for sidelink (SL) co-channel coexistence of Long-Term Evolution (LTE) and New Radio (NR).

### BACKGROUND

An objective on co-channel coexistence for Long-Term Evolution (LTE) sidelink (SL) and New Radio (NR) sidelink has been specified for upcoming studies in 3GPP Release 18 Sidelink Evolution as described in WID RP-213634, that is to “study and specify, if necessary, mechanism(s) for co-channel coexistence for LTE sidelink and NR sidelink including performance, necessity, feasibility, and potential specification impact if any [RAN1, RAN2, RAN4]”, and to “reuse the in-device coexistence framework defined in Rel-16 as much as possible”.

In Release 16, the in-device coexistence (e.g. for different spectrums) has been specified in TS38.213 that the higher priority packet will be prioritized when involving SL transmission while up to implementation for other cases (as summarized in Table 1 below).

TABLE 1

| | Overlaps of: | | | |
|---|---|---|---|---|
| | LIB TX | LTE TX | LIE RX | LTE RX |
| Conditions: | NR TX | NR RX | NR TX | NRRX |
| If packet priorities | Transmit pocker with | Transmit/Receive | Transmit/Receive | UE implememation |
| are known: | higher priority | pocket with higher | pocket with higher | |
| | | priority | priority | |
| In case same | UE implementation | UE implementation | UE implementation | UE implementation |
| priority: | | | | |
| If packet priorities | | UE implementation | UE Implementation | UE implementation |
| are not known: | | | | |

However, there has still been no discussion on communication apparatuses and methods for SL co-channel coexistence of LTE and NR.

There is thus a need for communication apparatuses and methods that provide feasible technical solutions for SL co-channel coexistence of LTE and NR. Furthermore, other desirable features and characteristics will become apparent from the subsequent detailed description and the appended claims, taken in conjunction with the accompanying drawings and this background of the disclosure.

### SUMMARY

Non-limiting and exemplary embodiments facilitate providing communication apparatuses and methods for SL co-channel coexistence of LTE and NR.

According to a first embodiment of the present disclosure, there is provided a communication apparatus comprising: circuitry, which in operation, selects a category from a plurality of categories including: a first category relating to a plurality of resources only for Long Term Evolution (LTE) sidelink, the LTE sidelink comprising LTE data and/or LTE sidelink control information (SCI), a second category relating to a plurality of resources only for New Radio (NR) sidelink, the NR sidelink comprising NR data and/or NR SCI, and a third category relating to a plurality of shared resources shared by the LTE sidelink and NR sidelink; and a transmitter, which in operation, transmits a sidelink data and/or SCI based on the selected category, wherein the sidelink data is the LTE or NR sidelink data and the sidelink SCI is the LTE or NR SCI.

According to a second embodiment of the present disclosure, there is provided a communication method comprising: selecting a category from a plurality of categories including: a first category relating to a plurality of resources only for Long Term Evolution (LTE) sidelink, the LTE sidelink comprising LTE data and/or LTE sidelink control information (SCI), a second category relating to a plurality of resources only for New Radio (NR) sidelink, the NR sidelink comprising NR data and/or NR SCI, and a third category relating to a plurality of resources shared by the LTE sidelink and NR sidelink; and transmitting a sidelink data and/or SCI based on the selected category, the sidelink data is the LTE or NR sidelink data and the SCI is the LTE or NR SCI.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

Embodiments of the disclosure will be better understood and readily apparent to one of ordinary skilled in the art from the following written description, by way of example only, and in conjunction with the drawings, in which:

FIG. 1 shows an exemplary 3GPP NR-RAN architecture to which exemplary embodiments of the present disclosure can be applied.

FIG. 2 depicts a schematic drawing which shows functional split between NG-RAN and 5G Core Network (5GC) to which exemplary embodiments of the present disclosure may be applied.

FIG. 3 depicts a sequence diagram for RRC (radio resource control) connection setup/reconfiguration procedures to which exemplary embodiments of the present disclosure may be applied.

FIG. 4 depicts a schematic drawing showing usage scenarios of Enhanced mobile broadband (eMBB), Massive Machine Type Communications (mMTC) and Ultra Reliable and Low Latency Communications (URLLC) to which exemplary embodiments of the present disclosure may be applied.

FIG. 5 shows a block diagram showing an exemplary 5G system architecture for vehicle to everything (V2X) communication in a non-roaming scenario to which exemplary embodiments of the present disclosure may be applied.

FIG. 6A shows an example illustration of a configuration of radio resources to avoid conflicts between LTE sidelink and NR sidelink according to an embodiment of the present disclosure.

FIG. 6B shows another example illustration of a configuration of radio resources to avoid conflicts between LTE sidelink and NR sidelink according to an embodiment of the present disclosure.

FIG. 7A shows an example illustration of a configuration of radio resources to handle conflicts between LTE and NR sidelinks according to an embodiment of the present disclosure.

FIG. 7B shows another example illustration of a configuration of radio resources to handle conflicts between LTE and NR sidelinks according to an embodiment of the present disclosure.

FIG. 8A shows an example illustration of a configuration of radio resources to handle conflicts between LTE and NR sidelinks according to an embodiment of the present disclosure.

FIG. 8B shows another example illustration of a configuration of radio resources to handle conflicts between LTE and NR sidelinks according to an embodiment of the present disclosure.

FIG. 9 shows a flow chart illustrating a communication method according to various embodiments.

FIG. 10 shows a schematic block diagram of an example communication apparatus in accordance with various embodiments.

Skilled artisans will appreciate that elements in the figures are illustrated for simplicity and clarity and have not necessarily been depicted to scale. For example, the dimensions of some of the elements in the illustrations, block diagrams or flowcharts may be exaggerated in respect to other elements to help to improve understanding of the present embodiments.

### DETAILED DESCRIPTION

Some embodiments of the present disclosure will be described, by way of example only, with reference to the drawings. Like reference numerals and characters in the drawings refer to like elements or equivalents.

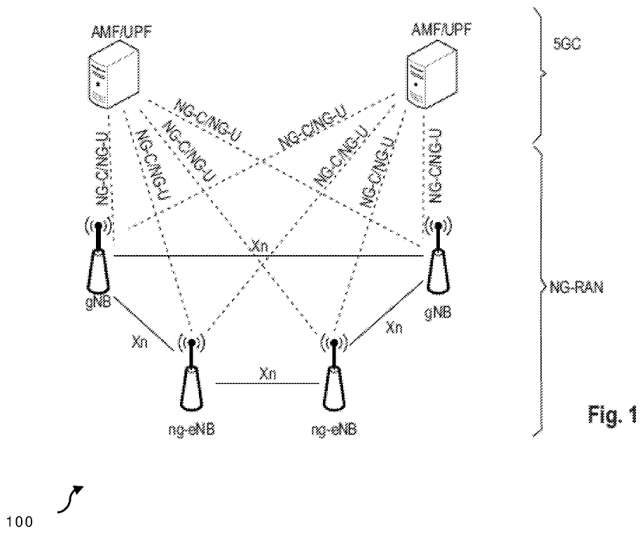

Among other things, the overall system architecture assumes an NG-RAN (Next Generation-Radio Access Network) that comprises gNBs, providing the NG-radio access user plane (SDAP/PDCP/RLC/MAC/PHY) and control plane (RRC) protocol terminations towards the user equipment (UE). The gNBs are interconnected with each other by means of the Xn interface. The gNBs are also connected by means of the Next Generation (NG) interface to the NGC (Next Generation Core), more specifically to the AMF (Access and Mobility Management Function) (e.g. a particular core entity performing the AMF) by means of the NG-C interface and to the UPF (User Plane Function) (e.g. a particular core entity performing the UPF) by means of the NG-U interface. The NG-RAN architecture 100 is illustrated in FIG. 1 (see e.g. 3GPP TS 38.300 v16.3.0, section 4).

The user plane protocol stack for NR (see e.g. 3GPP TS 38.300, section 4.4.1) comprises the PDCP (Packet Data Convergence Protocol, see section 6.4 of TS 38.300), RLC (Radio Link Control, see section 6.3 of TS 38.300) and MAC (Medium Access Control, see section 6.2 of TS 38.300) sublayers, which are terminated in the gNB on the network side. Additionally, a new access stratum (AS) sublayer (SDAP, Service Data Adaptation Protocol) is introduced above PDCP (see e.g. sub-clause 6.5 of 3GPP TS 38.300). A control plane protocol stack is also defined for NR (see for instance TS 38.300, section 4.4.2). An overview of the Layer 2 functions is given in sub-clause 6 of TS 38.300. The functions of the PDCP, RLC and MAC sublayers are listed respectively in sections 6.4, 6.3, and 6.2 of TS 38.300. The functions of the RRC layer are listed in sub-clause 7 of TS 38.300. Further, sidelink communications is introduced in 3GPP TS 38.300 v16.3.0. Sidelink supports UE-to-UE direct communication using the sidelink resource allocation modes, physical-layer signals/channels, and physical layer procedures (see for instance section 5.7 of TS 38.300).

For instance, the Medium-Access-Control layer handles logical-channel multiplexing, and scheduling and scheduling-related functions, including handling of different numerologies.

The physical layer (PHY) is for example responsible for coding, PHY HARQ processing, modulation, multi-antenna processing, and mapping of the signal to the appropriate physical time-frequency resources. It also handles mapping of transport channels to physical channels. The physical layer provides services to the MAC layer in the form of transport channels. A physical channel corresponds to the set of time-frequency resources used for transmission of a particular transport channel, and each transport channel is mapped to a corresponding physical channel. For instance, the physical channels are Physical Random Access Channel (PRACH), Physical Uplink Shared Channel (PUSCH) and Physical Uplink Control Channel (PUCCH) for uplink and Physical Downlink Shared Channel (PDSCH), Physical Downlink Control Channel (PDCCH) and Physical Broadcast Channel (PBCH) for downlink. Further, physical sidelink channels include Physical Sidelink Control Channel (PSCCH), Physical Sidelink Shared Channel (PSSCH), Physical Sidelink Feedback Channel (PSFCH) and Physical Sidelink Broadcast Channel (PSBCH).

Use cases/deployment scenarios for NR could include enhanced mobile broadband (eMBB), ultra-reliable low-latency communications (URLLC), massive machine type communication (mMTC), which have diverse requirements in terms of data rates, latency, and coverage. For example, eMBB is expected to support peak data rates (20 Gbps for downlink and 10 Gbps for uplink) and user-experienced data rates in the order of three times what is offered by IMT-Advanced. On the other hand, in case of URLLC, the tighter requirements are put on ultra-low latency (0.5 ms for UL and DL each for user plane latency) and high reliability (1-10⁻⁵ within 1 ms). Finally, mMTC may preferably require high connection density (1,000,000 devices/km² in an urban environment), large coverage in harsh environments, and extremely long-life battery for low cost devices (15 years).

Therefore, the OFDM numerology (e.g. subcarrier spacing, OFDM symbol duration, cyclic prefix (CP) duration, number of symbols per scheduling interval) that is suitable for one use case might not work well for another. For example, low-latency services may preferably require a shorter symbol duration (and thus larger subcarrier spacing) and/or fewer symbols per scheduling interval (aka, TTI) than a mMTC service. Furthermore, deployment scenarios with large channel delay spreads may preferably require a longer CP duration than scenarios with short delay spreads. The subcarrier spacing should be optimized accordingly to retain the similar CP overhead. NR may support more than one value of subcarrier spacing. Correspondingly, subcarrier spacing of 15 kHz, 30 kHz, 60 kHz . . . are being considered at the moment. The symbol duration Tᵤ and the subcarrier spacing Δf are directly related through the formula Δf=1/Tᵤ. In a similar manner as in LTE systems, the term “resource element” can be used to denote a minimum resource unit being composed of one subcarrier for the length of one OFDM/SC-FDMA symbol.

In the new radio system 5G-NR for each numerology and carrier a resource grid of subcarriers and OFDM symbols is defined respectively for uplink and downlink. Each element in the resource grid is called a resource element and is identified based on the frequency index in the frequency domain and the symbol position in the time domain (see 3GPP TS 38.211 v16.3.0).

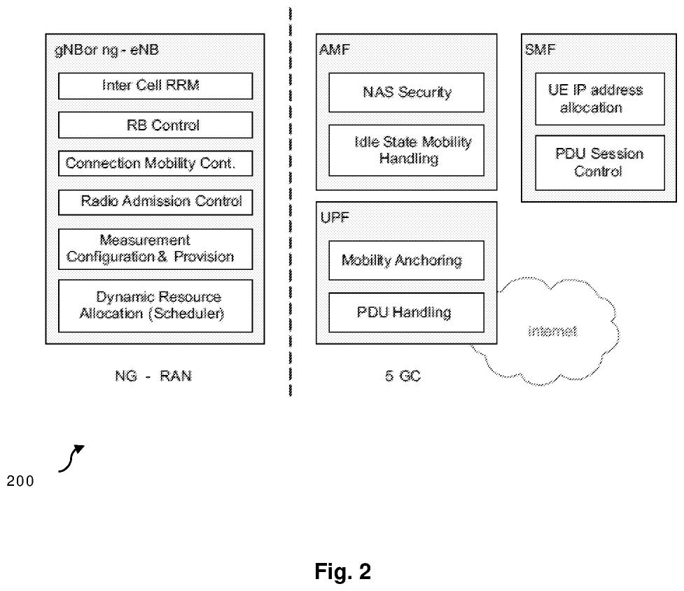

Schematic drawing 200 of FIG. 2 illustrates functional split between NG-RAN and 5GC. NG-RAN logical node is a gNB or ng-eNB. The 5GC has logical nodes Access and Mobility Management Function (AMF), User Plane Function (UPF) and Session Management Function (SMF).

In particular, the gNB and ng-eNB host the following main functions:
Functions for Radio Resource Management such as Radio Bearer Control, Radio Admission Control, Connection Mobility Control, Dynamic allocation of resources to UEs in both uplink and downlink (scheduling);
IP header compression, encryption and integrity protection of data;
Selection of an AMF at UE attachment when no routing to an AMF can be determined from the information provided by the UE;
Routing of User Plane data towards UPF(s);
Routing of Control Plane information towards AMF;
Connection setup and release;
Scheduling and transmission of paging messages;
Scheduling and transmission of system broadcast information (originated from the AMF or OAM);
Measurement and measurement reporting configuration for mobility and scheduling;
Transport level packet marking in the uplink;
Session Management;
Support of Network Slicing;
QoS Flow management and mapping to data radio bearers;
Support of UEs in RRC_INACTIVE state;
Distribution function for NAS messages;
Radio access network sharing;
Dual Connectivity;
Tight interworking between NR and E-UTRA.

The Access and Mobility Management Function (AMF) hosts the following main functions:
Non-Access Stratum, NAS, signaling termination;
NAS signaling security;
Access Stratum, AS, Security control;
Inter Core Network, CN, node signaling for mobility between 3GPP access networks;
Idle mode UE Reachability (including control and execution of paging retransmission);
Registration Area management;
Support of intra-system and inter-system mobility;
Access Authentication;
Access Authorization including check of roaming rights;
Mobility management control (subscription and policies);
Support of Network Slicing;
Session Management Function, SMF, selection.

Furthermore, the User Plane Function, UPF, hosts the following main functions:
Anchor point for Intra-/Inter-RAT mobility (when applicable);
External PDU session point of interconnect to Data Network;
Packet routing & forwarding;
Packet inspection and User plane part of Policy rule enforcement;
Traffic usage reporting;
Uplink classifier to support routing traffic flows to a data network;
Branching point to support multi-homed PDU session;
QoS handling for user plane, e.g. packet filtering, gating, UL/DL rate enforcement;
Uplink Traffic verification (SDF to QoS flow mapping);
Downlink packet buffering and downlink data notification triggering.

Finally, the Session Management function, SMF, hosts the following main functions:
Session Management;
UE IP address allocation and management;
Selection and control of UP function;
Configures traffic steering at User Plane Function, UPF, to route traffic to proper destination;
Control part of policy enforcement and QoS;
Downlink Data Notification.

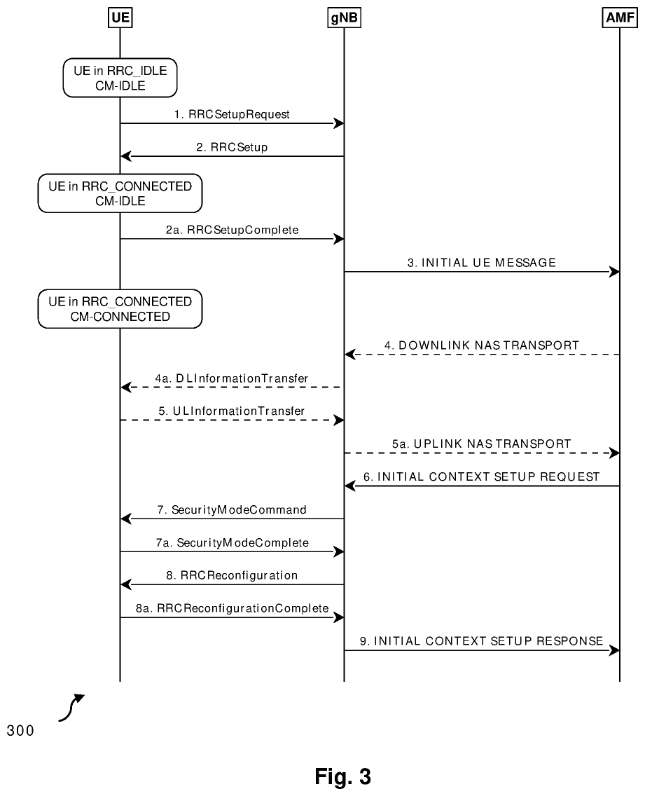

Sequence diagram 300 in FIG. 3 illustrates some interactions between a UE, gNB, and AMF (an 5GC entity) in the context of a transition of the UE from RRC_IDLE to RRC_CONNECTED for the NAS part (see TS 38.300 v16.3.0). The transition steps are as follows:
1. The UE requests to setup a new connection from RRC_IDLE.
2/2a. The gNB completes the RRC setup procedure.

NOTE: The scenario where the gNB rejects the request is described below.
3. The first NAS message from the UE, piggybacked in RRCSetupComplete, is sent to AMF.
4/4a/5/5a. Additional NAS messages may be exchanged between UE and AMF, see TS 23.502 reference (3GPP TS 23.122: “Non-Access-Stratum (NAS) functions related to Mobile Station in idle mode”).
6. The AMF prepares the UE context data (including PDU session context, the Security Key, UE Radio Capability and UE Security Capabilities, etc.) and sends it to the gNB.
7/7a. The gNB activates the AS security with the UE.
8/8a. The gNB performs the reconfiguration to setup SRB2 and DRBs.
9. The gNB informs the AMF that the setup procedure is completed.

RRC is a higher layer signalling (protocol) used for UE and gNB configuration. In particular, this transition involves that the AMF prepares the UE context data (including e.g. PDU session context, the Security Key, UE Radio Capability and UE Security Capabilities, etc.) and sends it to the gNB with the INITIAL CONTEXT SETUP REQUEST. Then, the gNB activates the AS security with the UE, which is performed by the gNB transmitting to the UE a SecurityModeCommand message and by the UE responding to the gNB with the SecurityModeComplete message. Afterwards, the gNB performs the reconfiguration to setup the Signaling Radio Bearer 2, SRB2, and Data Radio Bearer(s), DRB(s) by means of transmitting to the UE the RRCReconfiguration message in and, response, receiving the by gNB RRCReconfigurationComplete from the UE. For a signaling-only connection, the steps relating to the RRCReconfiguration are skipped since SRB2 and DRBs are not setup. Finally, the gNB informs the AMF that the setup procedure is completed with the INITIAL CONTEXT SETUP RESPONSE.

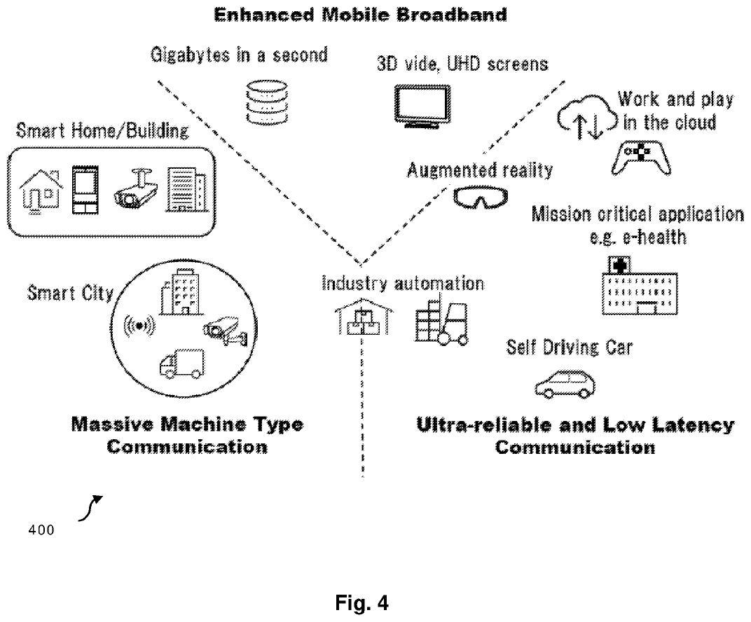

Schematic drawing 400 in FIG. 4 illustrates some of the use cases for 5G NR. In 3rd generation partnership project new radio (3GPP NR), three use cases are being considered that have been envisaged to support a wide variety of services and applications by IMT-2020. The technical specification for the phase 1 of enhanced mobile-broadband (eMBB) has been concluded. In addition to further extending the eMBB support, the current and future work would involve the standardization for ultra-reliable and low-latency communications (URLLC) and massive machine-type communications. FIG. 4 illustrates some examples of envisioned usage scenarios for IMT for 2020 and beyond (see e.g. ITU-R M.2083 FIG. 2).

The URLLC use case has stringent requirements for capabilities such as throughput, latency and availability and has been envisioned as one of the enablers for future vertical applications such as wireless control of industrial manufacturing or production processes, remote medical surgery, distribution automation in a smart grid, transportation safety, etc. Ultra-reliability for URLLC is to be supported by identifying the techniques to meet the requirements set by TR 38.913. For NR URLLC in Release 15, key requirements include a target user plane latency of 0.5 ms for UL (uplink) and 0.5 ms for DL (downlink). The general URLLC requirement for one transmission of a packet is a BLER (block error rate) of 1E-5 for a packet size of 32 bytes with a user plane latency of 1 ms.

From the physical layer perspective, reliability can be improved in a number of possible ways. The current scope for improving the reliability involves defining separate CQI tables for URLLC, more compact DCI formats, repetition of PDCCH, etc. However, the scope may widen for achieving ultra-reliability as the NR becomes more stable and developed (for NR URLLC key requirements). Particular use cases of NR URLLC in Rel. 15 include Augmented Reality/Virtual Reality (AR/VR), e-health, e-safety, and mission-critical applications.

Moreover, technology enhancements targeted by NR URLLC aim at latency improvement and reliability improvement. Technology enhancements for latency improvement include configurable numerology, mini-slot-based scheduling with flexible mapping, grant free (configured grant) uplink, mini-slot-level repetition for data channels, and downlink pre-emption. Pre-emption means that a transmission for which resources have already been allocated is stopped, and the already allocated resources are used for another transmission that has been requested later, but has lower latency/higher priority requirements. Accordingly, the already granted transmission is pre-empted by a later transmission. Pre-emption is applicable independent of the particular service type. For example, a transmission for a service-type A (URLLC) may be pre-empted by a transmission for a service type B (such as eMBB). Technology enhancements with respect to reliability improvement include dedicated Channel Quality Indicator/Modulation and Coding Scheme (CQI/MCS) tables for the target BLER of 1E-5.

The use case of mMTC (massive machine type communication) is characterized by a very large number of connected devices typically transmitting a relatively low volume of non-delay sensitive data. Devices are required to be low cost and to have a very long battery life. From NR perspective, utilizing very narrow bandwidth parts is one possible solution to have power saving from UE perspective and enable long battery life.

As mentioned above, it is expected that the scope of reliability in NR becomes wider. One key requirement to all the cases, and especially necessary for URLLC and mMTC, is high reliability or ultra-reliability. Several mechanisms can be considered to improve the reliability from radio perspective and network perspective. In general, there are a few key potential areas that can help improve the reliability. Among these areas are compact control channel information, data/control channel repetition, and diversity with respect to frequency, time and/or the spatial domain. These areas are applicable to reliability in general, regardless of particular communication scenarios.

For NR URLLC, further use cases with tighter requirements have been identified such as factory automation, transport industry and electrical power distribution, including factory automation, transport industry, and electrical power distribution. The tighter requirements are higher reliability (up to 10⁻⁶ level), higher availability, packet sizes of up to 256 bytes, time synchronization down to the order of a few us where the value can be one or a few us depending on frequency range and short latency in the order of 0.5 to 1 ms in particular a target user plane latency of 0.5 ms, depending on the use cases.

Moreover, for NR URLLC, several technology enhancements from the physical layer perspective have been identified. Among these are PDCCH (Physical Downlink Control Channel) enhancements related to compact DCI, PDCCH repetition, increased PDCCH monitoring. Moreover, UCI (Uplink Control Information) enhancements are related to enhanced HARQ (Hybrid Automatic Repeat Request) and CSI feedback enhancements. Also PUSCH enhancements related to mini-slot level hopping and retransmission/repetition enhancements have been identified. The term “mini-slot” refers to a Transmission Time Interval (TTI) including a smaller number of symbols than a slot (a slot comprising fourteen symbols).

The 5G QOS (Quality of Service) model is based on QoS flows and supports both QoS flows that require guaranteed flow bit rate (GBR QoS flows) and QoS flows that do not require guaranteed flow bit rate (non-GBR QoS Flows). At NAS level, the QoS flow is thus the finest granularity of QoS differentiation in a PDU session. A QoS flow is identified within a PDU session by a QoS flow ID (QFI) carried in an encapsulation header over NG-U interface.

For each UE, 5GC establishes one or more PDU Sessions. For each UE, the NG-RAN establishes at least one Data Radio Bearers (DRB) together with the PDU Session, and additional DRB(s) for QoS flow(s) of that PDU session can be subsequently configured (it is up to NG-RAN when to do so), e.g. as shown above with reference to FIG. 3. The NG-RAN maps packets belonging to different PDU sessions to different DRBs. NAS level packet filters in the UE and in the 5GC associate UL and DL packets with QoS Flows, whereas AS-level mapping rules in the UE and in the NG-RAN associate UL and DL QoS Flows with DRBs.

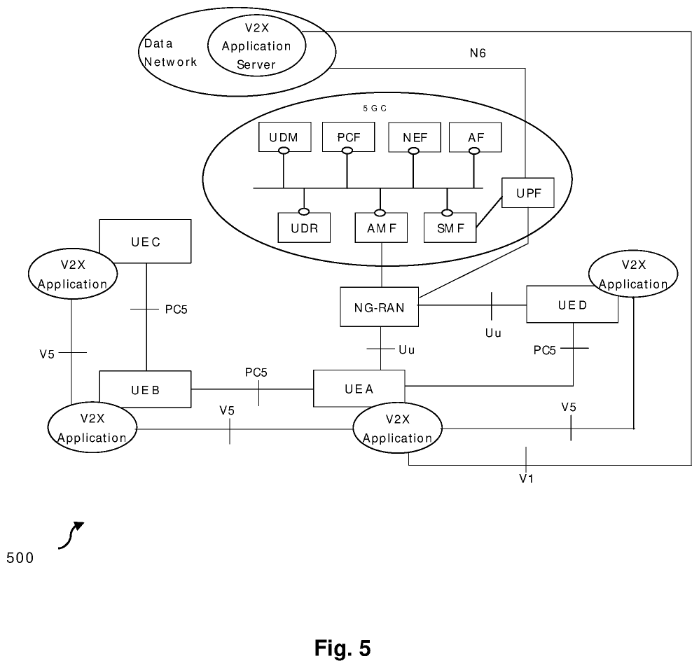

Block diagram 500 in FIG. 5 illustrates a 5G NR non-roaming reference architecture (see TS 23.287 v16.4.0, section 4.2.1.1). An Application Function (AF), e.g. an external application server hosting 5G services, exemplarily described in FIG. 4, interacts with the 3GPP Core Network in order to provide services, for example to support application influence on traffic routing, accessing Network Exposure Function (NEF) or interacting with the Policy framework for policy control (see Policy Control Function, PCF), e.g. QoS control. Based on operator deployment, Application Functions considered to be trusted by the operator can be allowed to interact directly with relevant Network Functions. Application Functions not allowed by the operator to access directly the Network Functions use the external exposure framework via the NEF to interact with relevant Network Functions.

FIG. 5 shows further functional units of the 5G architecture for V2X communication, namely, Unified Data Management (UDM), Policy Control Function (PCF), Network Exposure Function (NEF), Application Function (AF), Unified Data Repository (UDR), Access and Mobility Management Function (AMF), Session Management Function (SMF), and User Plane Function (UPF) in the 5GC, as well as with V2X Application Server (V2AS) and Data Network (DN), e.g. operator services, Internet access or 3rd party services. All of or a part of the core network functions and the application services may be deployed and running on cloud computing environments.

For co-channel coexistence of LTE sidelink and NR sidelink, both RATs (radio access technology) may allocate same time/frequency resources as they share the same radio spectrum. This is different from R16 in-device coexistence in which LTE and NR sidelinks are separated. As such, there is a desire to provide a mechanism which deals with the co-channel coexistence of LTE sidelink and NR sidelink.

One possible solution for this issue is to leave it up to gNB scheduling for SL with a base-station. Another solution is to simply reuse all rules specified for R16 in-device coexistence for SL without base-stations. However, there are issues, such as how to prioritize the packets with higher priority when transmission is involved, and UE implementation is required for all other cases.

For co-channel coexistence for LTE sidelink and NR sidelink, the radio resources may be categorized for different purposes. For instance, there may be resources for LTE sidelink only, resources for NR sidelink only, and resources shared by both LTE sidelink and NR sidelink. The categorizations' visibility may be different for different UEs. For UEs supporting resources shared by LTE sidelink and NR sidelink, they may identify all categories; while for UEs not supporting resources shared by LTE sidelink and NR sidelink, they may only identify some of the categories (e.g., the first one or two categories only).

The resources may be realized as configurable sets (e.g., resource pools), or segregated in time or frequency (by regulators, vendors, etc). Resources for different purposes may be exclusive or overlapped with one another. The resources may be further separated for transmission (TX) or reception (RX) purposes.

In an embodiment, for a RF band (e.g., Intelligent Transport Systems (ITS) band) that both LTE sidelink and NR sidelink can access, the band may be configured with different types of resource pools such as resource pool(s) for LTE sidelink only, resource pool(s) for NR sidelink only, and resource pool(s) shared by both LTE sidelink and NR sidelink (e.g. shared resources). For the first two types of resource pool(s), only for LTE UEs and NR UEs are able to access respectively. For the resource pool(s) shared by LTE sidelink and NR sidelink, both LTE UEs and NR UEs would be able to access. For LTE-only UEs, they may be configured to treat the shared pool in a same manner as that for an LTE-only pool. For NR-only UEs, they may be configured to treat the shared pool in a same manner as that for an NR-only pool. For UEs supporting both LTE and NR without capability for shared resources, they may treat the shared pool(s) as LTE-only or NR-only resource pool(s) by configuration, pre-configuration or specified behavior. Each of these resource pools may also be referred to a plurality of resources. The plurality of resources only for LTE sidelink, the plurality of resources only for NR sidelink and the plurality of shared resources shared by LTE sidelink and NR sidelink may be indicated by a physical or higher layer signaling, or may be defined in a technical specification.

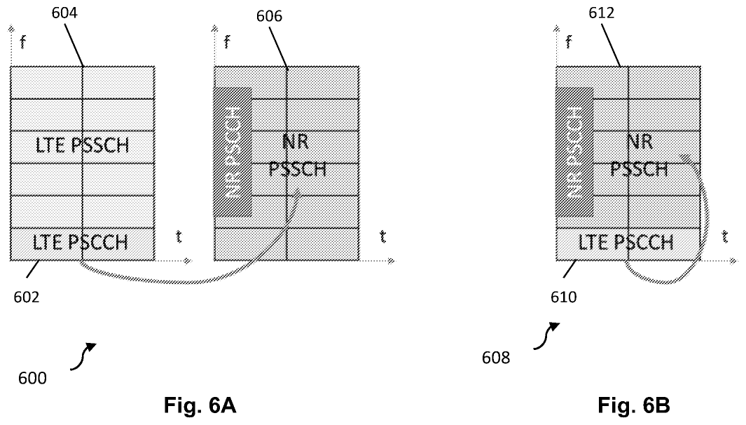

For UEs supporting both LTE and NR with capability for shared resources, when NR SL TX is performed, reservation and/or indication (e.g. control information reserving, indicating or relating to one or more resources of NR) may be signaled by LTE signaling defined in LTE/LTE-Advanced system or to be defined in LTE/LTE-Advanced system (e.g., sidelink control information (SCI)), so that LTE UEs will be able to skip the resources used by NR. The LTE reservation and/or indication may be prior to a NR transmission as shown in illustration 600 of FIG. 6A. For example, a LTE or NR transmission such as a LTE Physical Sidelink Control Channel (PSCCH) 602 is transmitted together with a LTE PSSCH 604 transmission prior to a transmission of NR PSSCH 606. The LTE reservation and/or indication may also be together with the NR transmission. For example, in illustration 608 of FIG. 6B, LTE Physical Sidelink Control Channel (PSCCH) 610 is transmitted together with a transmission of NR PSSCH 612. This arrangement requires simultaneous LTE and NR TX.

Alternatively, the SCI information can be via different Radio Access Technology (RAT, e.g. LTE, NR, etc) signaling according to the receiving UEs. For the information to be received by LTE-only UEs, UEs that are capable of utilizing shared resources may also receive the information via LTE sidelink resources instead of NR. For the information to be received by NR capable UEs, UEs that are capable of utilizing shared resources may also receive the information via NR sidelink resources.

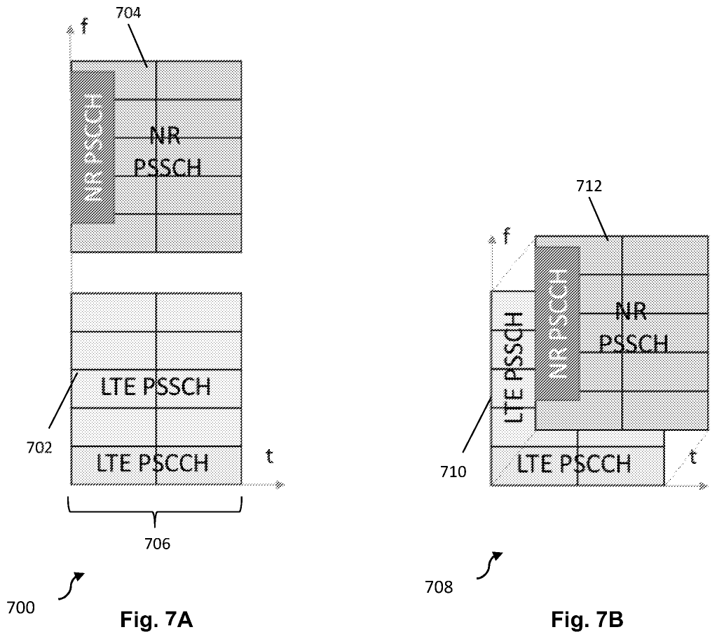

According to an embodiment of the present disclosure, in order to segregate LTE/NR sidelink and to reserve/indicate transmission to handle conflicts between LTE and NR sidelinks, some conflicts handling rule may also be utilized. Such conflicts occur when there are LTE SL (Tx or Rx) and NR SL (Tx or Rx) at same time for a UE or for a system. The conflict cases can be categorized as: [LTE TX, NR TX]; [LTE TX, NR RX]; [LTE RX, NR TX]; [LTE RX, NR RX]. For the conflict cases of [LTE TX, NR TX], [LTE TX, NR RX], [LTE RX, NR TX], the same R16 priority rules for Tx/Rx packet with higher priority can be reused. For the conflict case of [LTE RX, NR RX], a simultaneous Rx capable SL UE may be defined such that the UE is capable of receiving both LTE PSCCH and NR PSCCH simultaneously. For such simultaneous Rx capable UEs, which RAT PSSCH is to be received may be decided by priority values with PSCCH, or other sidelink control information on PSCCH or PSSCH and/or signals (e.g., sidelink channel state information (SL-CSI)) and/or reports (e.g., SL measurement report). The LTE/NR may be frequency division multiplexed (FDMed) in a same slot such as shown in illustration 700 of FIG. 7A (e.g. LTE RX 702 and NR RX 704 may be in a same slot 706), or overlapped via code/spatial segregation as shown in illustration 708 of FIG. 7B (e.g. LTE RX 710 and NR RX 712 are overlapping with each other in time and/or frequency domain).

For any conflict case where there is same priority for LTE and NR, or when priorities are unknown, a SL UE may choose to (1) prioritize one from LTE TX, LTE RX, NR TX and NR RX, (2) prioritize packets with a certain UE type (e.g., Tx-only, Rx-only, roadside unit (RSU), etc), and (3) one or more combinations of the above (e.g., RSU with LTE-Tx, Tx-only UE with LTE-Tx, etc).

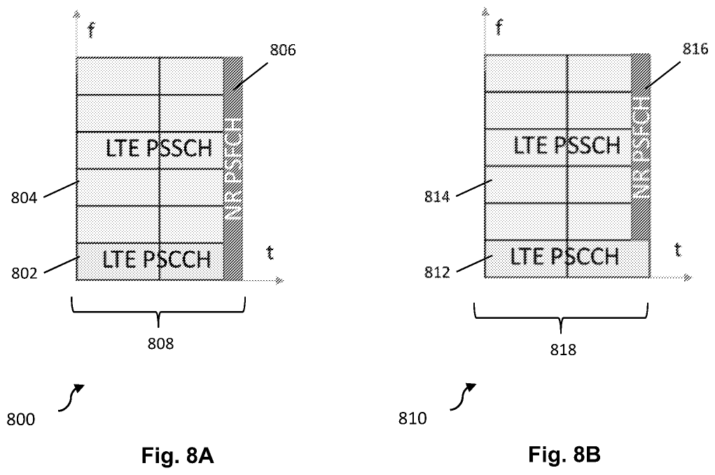

The Tx/Rx of NR PSFCH was treated same as regular NR Tx/Rx during discussion for in-device coexistence as LTE and NR are with different spectrums. For co-channel co-existence, some optimization may be applied as PSFCH only occupies the last ⅔ symbols (except the guarding symbol) within a slot. For more efficient resource utilization, when NR PSFCH conflicts with LTE, a UE may be configured to transmit LTE PSCCH/PSSCH at a shortened length together with NR PSFCH in a same slot such as shown in FIGS. 8A and 8B. For example, in illustration 800 of FIG. 8A, LTE PSCCH 802 and LTE PSSCH 804 are time division multiplexed (TDMed) with NR PSFCH 806 in a same slot 808, and in illustration 810 of FIG. 8B, LTE PSSCH 814 is TDMed with NR PSFCH 816 in a same slot 818, and the combination is FDMed with LTE PSCCH 812. In both illustrations, the LTE portion may use the first 10 symbols while NR PSFCH may use the next 3 symbols. These examples require different or modified MCS from current LTE and NR technical specifications, and/or different or modified resource element mapping rules for LTE PSSCH and/or LTE PSCCH so that the data can be correctly mapped to radio resources accessible by both NR and LTE UEs. Alternatively, a UE may be configured to prioritize packets with PSFCH Tx/Rx, or prioritize higher priority packets by comparing the priority of NR PSCCH with the LTE PSCCH priority or LTE PSSCH priority.

In an embodiment of the present disclosure, for the conflicting case of [LTE TX, NR TX], other than R16 in-device coexistence dropping rules, some optimization on dynamic power sharing may also be considered for simultaneous transmissions. When a sum of LTE and NR default powers is lower than the limit of a maximum allowed Tx power of a UE e.g. P_{cmax}, a UE may perform simultaneous transmission.

When the sum of LTE and NR default powers is greater than the limit of P_{cmax}, and when priority from both RATs are known with different values, a UE may transmit (1) the RAT (solely) with higher priority packet and drop the other RAT packet(s), (2) packets of the (pre-) configured prioritized RAT and drop the other RAT packet(s), (3) the RAT with higher priority packet at its default power (e.g., P_{PSSCH,LTE}), and transmit the RAT with lower priority packet at remaining power (e.g., P_{PSSCH,NR}=P_{cmax}−P_{PSSCH,LTE}), (4) the RAT with higher priority packet at higher weightage (e.g., P_{PSSCH,LTE}=a*P_{cmax}), and transmit the RAT with lower priority packet at lower weightage (e.g., P_{PSSCH,NR}=b*P_{cmax}), (where a>b, and a+b≤1). On the other hand, if priority from both RATs are known with same values, a UE may transmit (1) Different RATs at same power, i.e., P_{PSSCH,NR}=P_{PSSCH,LTE}≤0.5*P_{cmax}, and (2) packets of the (pre-) configured prioritized RAT and drop the other RAT packet(s). In an implementation, when priority from both RATs are unknown, a UE may transmit (1) different RATs at same power, i.e., P_{PSSCH,NR}=P_{PSSCH,LTE}≤0.5*P_{cmax}, (2) packets of the (pre-) configured prioritized RAT and drop the other RAT packet(s), (3) packets which gNB (if mode-1) semi-statically configured UE to prioritize LTE or NR, (4) (pre-) configured prioritized RAT's packet at its default power (e.g., P_{PSSCH,LTE}), and transmit the other RAT's with lower priority packet at remaining power (e.g., P_{PSSCH,NR}=P_{cmax}−P_{PSSCH,LTE}), and (5) prioritized RAT's packet at a higher weighted P_{cmax} (e.g., P_{PSSCH,LTE}=a*P_{cmax}), and transmit the other RAT's packet at a lower weighted P_{cmax} (e.g., P_{PSSCH,NR}=b*P_{cmax}) (where a>b, and a+b≤1). In such transmissions, the demodulation reference signals (DMRS) in different symbols may be affected and certain pattern(s) may be disabled for simultaneous transmission of LTE SL and NR SL.

A UE may be configured to first try to use LTE-only or NR-only resource pools, and if a condition (e.g., the Channel Busy Ratio/Channel Occupancy Ratio (CBR/CR) exceeds some threshold) is met, the UE may try to switch to the shared LTE/NR resource pool.

For resource pool(s) shared for LTE SL and NR SL, resource pool can be free-to-use by either LTE and NR SLs. The resource pool(s) may also be segregated e.g., some portion for LTE SL and some other portion for NR SL.

For resource pool(s) shared by LTE SL and NR SL, LTE scheduling resources for NR may be not meaningful if LTE schedules resource for NR in PHY layer. NR scheduling resources for LTE may be achieved by some reserved bits in a 1st stage SCI transmission, or new 2nd stage SCI formats may be used to indicate LTE scheduling or scheduled LTE resources. LTE reports to NR, and NR reports to LTE on resource allocation of a RAT may be reports by payload (but not by physical layer) to another RAT or to another UE.

For resource pool(s) shared by LTE SL and NR SL, it may also be specified that periodic reservation of LTE V2X is used for LTE V2X, and the remaining resource is used for NR V2X. The dynamically scheduled NR may be prioritized over LTE even with lower priority.

As LTE subcarrier spacing (SCS) is 15 kHz only while NR have multiple choices of 15/30/60/120 KHz, the resource pool(s) shared by LTE SL and NR SL may be limited to 15 kHz SCS.

For long term time-scale coordination, the resource pool being utilized may be simply treated as an LTE-only or NR-only resource pool. R16 rules could still be reused. For short term time-scale coordination, dynamic scheduling and handling may be required. For long term time-scale mixed with short term time-scale coordination, it would be treated as either the same as short term time-scale coordination, or treated as an LTE/NR shared resource pool (long term) with dynamically scheduled NR/LTE SL (short-term).

For UEs supporting both LTE SL and NR SL, all UEs supporting both LTE SL and NR SL may have access to the resource(s) or resource pool(s) shared by LTE sidelink and NR sidelink, or only some UEs supporting both LTE SL and NR SL may have access to the resource(s) or resource pool(s) shared by LTE sidelink and NR sidelink, and some other UEs supporting both LTE SL and NR SL have no access to the resource(s) or resource pool(s) shared by LTE sidelink and NR sidelink.

A UE may assign/indicate the resource of another UE based on the categories of resources. Further, the above-described embodiments and examples may apply for SL UEs without base-station scheduling (LTE mode-4, NR mode-2), for SL UEs with base-station scheduling (LTE mode-3, NR mode-1).

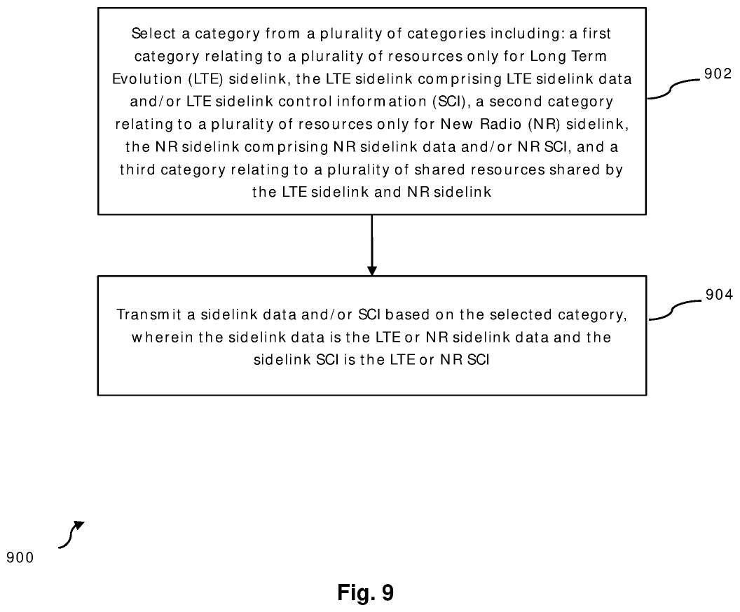

FIG. 9 shows a flow diagram 900 illustrating a communication method according to various embodiments. In step 902, a category is selected from a plurality of categories including: a first category relating to a plurality of resources only for Long Term Evolution (LTE) sidelink, the LTE sidelink comprising LTE sidelink data and/or LTE sidelink control information (SCI), a second category relating to a plurality of resources only for New Radio (NR) sidelink, the NR sidelink comprising NR sidelink data and/or NR SCI, and a third category relating to a plurality of resources shared by the LTE sidelink and NR sidelink. In step 904, a sidelink data and/or SCI is transmitted based on the selected category, the sidelink data is the LTE or NR sidelink data and the SCI is the LTE or NR SCI.

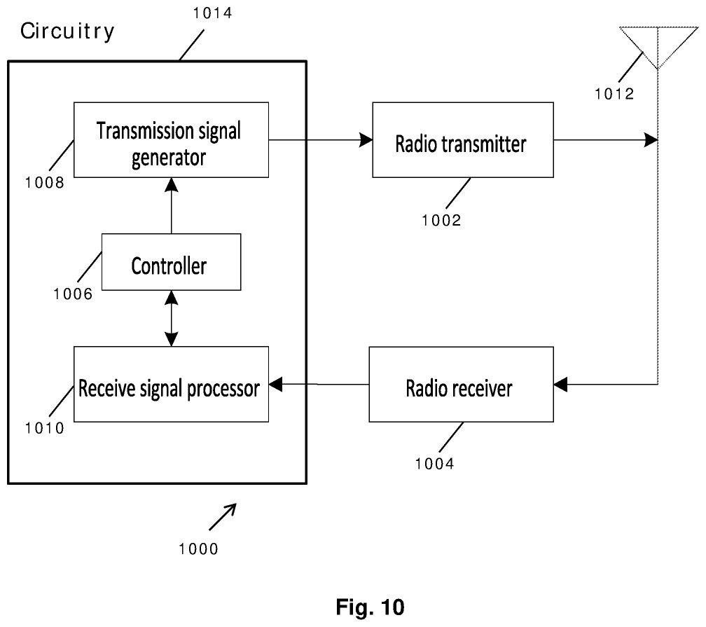

FIG. 10 shows a schematic, partially sectioned view of the communication apparatus 1000 that can be implemented for in accordance with various embodiments and examples as shown in FIGS. 1 to 9. The communication apparatus 1000 may be implemented as a UE or base station according to various embodiments.

Various functions and operations of the communication apparatus 1000 are arranged into layers in accordance with a hierarchical model. In the model, lower layers report to higher layers and receive instructions therefrom in accordance with 3GPP technical specifications. For the sake of simplicity, details of the hierarchical model are not discussed in the present disclosure.

As shown in FIG. 10, the communication apparatus 1000 may include circuitry 1014, at least one radio transmitter 1002, at least one radio receiver 1004, and at least one antenna 1012 (for the sake of simplicity, only one antenna is depicted in FIG. 10 for illustration purposes). The circuitry 1014 may include at least one controller 1006 for use in software and hardware aided execution of tasks that the at least one controller 1006 is designed to perform, including control of communications with one or more other communication apparatuses in a wireless network. The circuitry 1014 may furthermore include at least one transmission signal generator 1008 and at least one receive signal processor 1010. The at least one controller 1006 may control the at least one transmission signal generator 1008 for generating signals (for example, a signal indicating a geographical zone) to be sent through the at least one radio transmitter 1002 to one or more other communication apparatuses and the at least one receive signal processor 1010 for processing signals (for example, a signal indicating a geographical zone) received through the at least one radio receiver 1004 from the one or more other communication apparatuses under the control of the at least one controller 1006. The at least one transmission signal generator 1008 and the at least one receive signal processor 1010 may be stand-alone modules of the communication apparatus 1000 that communicate with the at least one controller 1006 for the above-mentioned functions, as shown in FIG. 10. Alternatively, the at least one transmission signal generator 1008 and the at least one receive signal processor 1010 may be included in the at least one controller 1006. It is appreciable to those skilled in the art that the arrangement of these functional modules is flexible and may vary depending on the practical needs and/or requirements. The data processing, storage and other relevant control apparatus can be provided on an appropriate circuit board and/or in chipsets. In various embodiments, when in operation, the at least one radio transmitter 1002, at least one radio receiver 1004, and at least one antenna 1012 may be controlled by the at least one controller 1006.

The communication apparatus 1000, when in operation, provides functions required for SL co-channel coexistence of LTE and NR. For example, the communication apparatus 1000 may be a UE, and the circuitry 1014 may, in operation, select a category from a plurality of categories including: a first category relating to a plurality of resources only for Long Term Evolution (LTE) sidelink, the LTE sidelink comprising LTE sidelink data and/or LTE sidelink control information (SCI), a second category relating to a plurality of resources only for New Radio (NR) sidelink, the NR sidelink comprising NR sidelink data and/or NR SCI, and a third category relating to a plurality of shared resources shared by the LTE sidelink and NR sidelink. The transmitter 1002 may, in operation, transmit a sidelink data and/or SCI based on the selected category, wherein the sidelink data is the LTE or NR sidelink data and the sidelink SCI is the LTE or NR SCI.

The plurality of resources only for LTE sidelink, the plurality of resources only for NR sidelink and the plurality of shared resources shared by LTE sidelink and NR sidelink may be indicated by a physical or higher layer signaling, or defined in a technical specification. The communication apparatus may be a LTE-only UE, and the circuitry 1014 may be further configured to select the first category or the third category. The communication apparatus 1000 may be a NR-only UE, and the circuitry 1014 may be further configured to select the second category or the third category. The communication apparatus 1000 may support both the LTE and NR sidelink without capability for the third category, and the circuitry 1014 may be further configured to select the first category or the second category based on a configuration, pre-configuration or specified behavior. The communication apparatus 1000 may support both the LTE and NR sidelink with capability for the third category, and the circuitry 1014 may be further configured to select the first category, the second category or the third category based on a configuration, pre-configuration or specified behavior. The transmitter 1002 may be further configured to transmit the NR sidelink, and the LTE SCI comprising an indication for LTE UEs to skip resources used by the NR sidelink in the plurality of shared resources, the LTE SCI being transmitted prior to or during the transmission of the NR sidelink.

Different radio resources may be assigned for the plurality of resources only for LTE sidelink, the plurality of resources only for NR sidelink and the plurality of shared resources shared by LTE sidelink and NR sidelink, and the transmitter 1002 may be further configured to transmit the sidelink data and/or the sidelink SCI using the radio resources that are assigned to the selected category. The transmitter 1002 may be further configured to skip a transmission occasion of the sidelink data and/or the sidelink SCI based on a reservation or an indication.

The communication apparatus 1000 may be a simultaneous Rx (receiving) capable UE, further comprising a receiver, which in operation, receives a LTE Physical Sidelink Control Channel (PSCCH) and NR PSCCH simultaneously based on priority values of the LTE PSCCH and the NR PSCCH, or based on other sidelink control information on PSCCH or Physical Sidelink Shared Channel (PSSCH), sidelink channel state information (SL-CSI) or SL measurement report. The LTE PSCCH and the NR PSCCH may be frequency domain multiplexed (FDMed) in a same slot, or overlapped with each other via a code or spatial segregation.

The circuitry 1014 may be further configured to prioritize one of the LTE sidelink transmission (Tx), a LTE sidelink Rx, the NR sidelink Tx and a NR sidelink Rx, or packets of a Tx-only UE type, Rx-only UE type, and road side unit (RSU), or a combination thereof. The transmitter 1002 may be further configured to transmit, in a slot, the LTE sidelink comprising a LTE PSCCH and/or LTE Physical Sidelink Shared Channel (PSSCH) with a shortened symbol length when a NR Physical Sidelink Feedback Channel (PSFCH) is also transmitted in the same slot. The NR PSFCH may be transmitted in last 2 or 3 symbols of the slot, and the LTE PSSCH may be transmitted in a part of symbols other than the last 2 or 3 symbols in the slot.

The transmitter 1002 may be further configured to transmit the LTE and the NR sidelink simultaneously when a sum of default power of the LTE sidelink and the NR sidelink is lower than a configured maximum possible output power (Pcmax) of the communication apparatus 1000. The transmitter 1002 may be further configured to transmit the LTE and NR sidelink data and/or SCI based on a priority value associated with the LTE sidelink and another priority value associated with the NR sidelink, when a sum of default power of the LTE sidelink and the NR sidelink is greater than a Pcmax of the communication apparatus 1000. The transmitter 1002 may be further configured to transmit the LTE sidelink or the NR sidelink with a higher priority packet at its default power and the respective NR sidelink or LTE sidelink with a lower priority packet at remaining power. The transmitter 1002 may be further configured to transmit the LTE sidelink or the NR sidelink with a higher priority packet at a higher weightage of power and the respective NR or LTE sidelink with a lower priority packet at a lower weightage of power.

### Control Signals

In the present disclosure, the downlink control signal (information) related to the present disclosure may be a signal (information) transmitted through PDCCH of the physical layer or may be a signal (information) transmitted through a MAC Control Element (CE) of the higher layer or the RRC. The downlink control signal may be a pre-defined signal (information).

The uplink control signal (information) related to the present disclosure may be a signal (information) transmitted through PUCCH of the physical layer or may be a signal (information) transmitted through a MAC CE of the higher layer or the RRC. Further, the uplink control signal may be a pre-defined signal (information). The uplink control signal may be replaced with uplink control information (UCI), the 1st stage sidelink control information (SCI) or the 2nd stage SCI.

### Base Station

In the present disclosure, the base station may be a Transmission Reception Point (TRP), a clusterhead, an access point, a Remote Radio Head (RRH), an eNodeB (eNB), a gNodeB (gNB), a Base Station (BS), a Base Transceiver Station (BTS), a base unit or a gateway, for example. Further, in side link communication, a terminal may be adopted instead of a base station. The base station may be a relay apparatus that relays communication between a higher node and a terminal. The base station may be a roadside unit as well.

### Uplink/Downlink/Sidelink

The present disclosure may be applied to any of uplink, downlink and sidelink.

The present disclosure may be applied to, for example, uplink channels, such as PUSCH, PUCCH, and PRACH, downlink channels, such as PDSCH, PDCCH, and PBCH, and side link channels, such as Physical Sidelink Shared Channel (PSSCH), Physical Sidelink Control Channel (PSCCH), and Physical Sidelink Broadcast Channel (PSBCH).

PDCCH, PDSCH, PUSCH, and PUCCH are examples of a downlink control channel, a downlink data channel, an uplink data channel, and an uplink control channel, respectively. PSCCH and PSSCH are examples of a sidelink control channel and a sidelink data channel, respectively. PBCH and PSBCH are examples of broadcast channels, respectively, and PRACH is an example of a random access channel.

### Data Channels/Control Channels

The present disclosure may be applied to any of data channels and control channels. The channels in the present disclosure may be replaced with data channels including PDSCH, PUSCH and PSSCH and/or control channels including PDCCH, PUCCH, PBCH, PSCCH, and PSBCH.

### Reference Signals

In the present disclosure, the reference signals are signals known to both a base station and a mobile station and each reference signal may be referred to as a Reference Signal (RS) or sometimes a pilot signal. The reference signal may be any of a DMRS, a Channel State Information-Reference Signal (CSI-RS), a Tracking Reference Signal (TRS), a Phase Tracking Reference Signal (PTRS), a Cell-specific Reference Signal (CRS), and a Sounding Reference Signal (SRS).

### Time Intervals

In the present disclosure, time resource units are not limited to one or a combination of slots and symbols, and may be time resource units, such as frames, superframes, subframes, slots, time slot subslots, minislots, or time resource units, such as symbols, Orthogonal Frequency Division Multiplexing (OFDM) symbols, Single Carrier-Frequency Division Multiplexing Access (SC-FDMA) symbols, or other time resource units. The number of symbols included in one slot is not limited to any number of symbols exemplified in the embodiment(s) described above, and may be other numbers of symbols.

### Frequency Bands

The present disclosure may be applied to any of a licensed band and an unlicensed band.

### Communication

The present disclosure may be applied to any of communication between a base station and a terminal (Uu-link communication), communication between a terminal and a terminal (Sidelink communication), and Vehicle to Everything (V2X) communication. The channels in the present disclosure may be replaced with PSCCH, PSSCH, Physical Sidelink Feedback Channel (PSFCH), PSBCH, PDCCH, PUCCH, PDSCH, PUSCH, and PBCH.

In addition, the present disclosure may be applied to any of a terrestrial network or a network other than a terrestrial network (NTN: Non-Terrestrial Network) using a satellite or a High Altitude Pseudo Satellite (HAPS). In addition, the present disclosure may be applied to a network having a large cell size, and a terrestrial network with a large delay compared with a symbol length or a slot length, such as an ultra-wideband transmission network.

### Antenna Ports

An antenna port refers to a logical antenna (antenna group) formed of one or more physical antenna(s). That is, the antenna port does not necessarily refer to one physical antenna and sometimes refers to an array antenna formed of multiple antennas or the like. For example, it is not defined how many physical antennas form the antenna port, and instead, the antenna port is defined as the minimum unit through which a terminal is allowed to transmit a reference signal. The antenna port may also be defined as the minimum unit for multiplication of a precoding vector weighting.

As described above, the embodiments of the present disclosure provide an advanced communication system, communication methods and communication apparatuses that advantageously achieve SL co-channel coexistence of LTE and NR.

The present disclosure can be realized by software, hardware, or software in cooperation with hardware. Each functional block used in the description of each embodiment described above can be partly or entirely realized by an LSI such as an integrated circuit, and each process described in the each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI here may be referred to as an IC, a system LSI, a super LSI, or an ultra LSI depending on a difference in the degree of integration. However, the technique of implementing an integrated circuit is not limited to the LSI and may be realized by using a dedicated circuit, a general-purpose processor, or a special-purpose processor. In addition, a FPGA (Field Programmable Gate Array) that can be programmed after the manufacture of the LSI or a reconfigurable processor in which the connections and the settings of circuit cells disposed inside the LSI can be reconfigured may be used. The present disclosure can be realized as digital processing or analogue processing. If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred as a communication apparatus.

Some non-limiting examples of such communication apparatus include a phone (e.g, cellular (cell) phone, smart phone), a tablet, a personal computer (PC) (e.g, laptop, desktop, netbook), a camera (e.g, digital still/video camera), a digital player (digital audio/video player), a wearable device (e.g, wearable camera, smart watch, tracking device), a game console, a digital book reader, a telehealth/telemedicine (remote health and medicine) device, and a vehicle providing communication functionality (e.g., automotive, airplane, ship), and various combinations thereof.

The communication apparatus is not limited to be portable or movable, and may also include any kind of apparatus, device or system being non-portable or stationary, such as a smart home device (e.g, an appliance, lighting, smart meter, control panel), a vending machine, and any other “things” in a network of an “Internet of Things (IoT)”.

The communication may include exchanging data through, for example, a cellular system, a wireless LAN system, a satellite system, etc., and various combinations thereof.

The communication apparatus may comprise a device such as a controller or a sensor which is coupled to a communication device performing a function of communication described in the present disclosure. For example, the communication apparatus may comprise a controller or a sensor that generates control signals or data signals which are used by a communication device performing a communication function of the communication apparatus.

The communication apparatus also may include an infrastructure facility, such as a base station, an access point, and any other apparatus, device or system that communicates with or controls apparatuses such as those in the above non-limiting examples.

It will be understood that while some properties of the various embodiments

have been described with reference to a device, corresponding properties also apply to the methods of various embodiments, and vice versa.

It will be appreciated by a person skilled in the art that numerous variations and/or modifications may be made to the present disclosure as shown in the specific embodiments without departing from the spirit or scope of the disclosure as broadly described. The present embodiments are, therefore, to be considered in all respects illustrative and not restrictive.

1.-19. (canceled)

20. A communication apparatus, comprising:
circuitry, which, in operation, determines a New Radio (NR) sidelink resource shared as a Long Term Evolution (LTE) sidelink resource; and
a transmitter, which in operation, performs transmission using the shared sidelink resource.

21. The communication apparatus of claim 20, wherein the shared sidelink resource is indicated by a physical or higher layer signaling, or defined in a technical specification.

22. The communication apparatus of claim 20, wherein each of the NR sidelink resource and the LTE sidelink resource is indicated by a higher layer signaling.

23. The communication apparatus of claim 20, wherein the circuitry, in operation, determines the shared sidelink resource based on a configuration, preconfiguration, or specified behavior.

24. The communication apparatus of claim 20, wherein the transmitter, in operation, skips a transmission occasion of the shared sidelink resource based on a reservation or an indication.

25. The communication apparatus of claim 20, wherein the circuitry, in operation, determines the NR sidelink resource based on a priority value associated with the LTE sidelink resource.

26. The communication apparatus of claim 20, wherein the circuitry, in operation, prioritizes a priority value associated with the NR sidelink resource than a priority value associated with the LTE sidelink resource.

27. The communication apparatus of claim 20, wherein the transmitter, in operation, transmit the LTE sidelink based on a priority value associated with the LTE sidelink.

28. A communication method, comprising:
determining a plurality of resources shared by a Long Term Evolution (LTE) sidelink and a New Radio (NR) sidelink; and
transmitting at least one of a sidelink data or a sidelink control information (SCI) using the plurality of shared resources.

29. An integrated circuit, comprising:
control circuitry, which, in operation, determines a plurality of shared resources shared by a Long Term Evolution (LTE) sidelink and a New Radio (NR) sidelink; and
transmitting circuitry, which, in operation, transmits at least one of a sidelink data or a sidelink control information (SCI) using the plurality of shared resources.
